(19) United States
(12) Patent Application Publication
(10) Pub. No.: US 2016/0160843 A1
(43) Pub. Date: Jun. 9, 2016

(54) SUPPORT STRUCTURE FOR SUPPORTING WIND TURBINE COMPONENTS

(71) Applicant: SIEMENS AKTIENGESELLSCHAFT, MUNCHEN (DE)

(72) Inventor: JENS BOMHOLT JENSEN, HORSENS (DK)

(21) Appl. No.: 14/685,809

(22) Filed: Apr. 14, 2015

(30) Foreign Application Priority Data
Dec. 5, 2014 (DE) 102014208934.4

(51) Int. Cl. E04H 12/00

(52) U.S. Cl. CPC F03D 11/04

(57) ABSTRACT

A support structure for supporting wind turbine components which are to be arranged or are arranged within a wind turbine nacelle that is to be arranged or is arranged on a tower construction, wherein the support structure includes at least two girder section structures which are connected together via at least one cross-connection structure, wherein the cross-connection structure includes at least two connecting struts which intersect in an intersection region is provided.

### CROSS-REFERENCE TO RELATED APPLICATIONS

This application claims priority to German Application No. DE 2014208934.4, having a filing date of May 12, 2014, the entire contents of which are hereby incorporated by reference.

### FIELD OF TECHNOLOGY

The following relates to a support structure for supporting wind turbine components which are to be arranged or are arranged within a wind turbine nacelle that is to be arranged or is arranged on a tower construction, wherein the support structure comprises at least two girder section structures which are connected together via at least one cross-connection structure.

### BACKGROUND

Corresponding support structures are known. An essential objective of such support structures is to stably and safely support wind turbine components, for example an electric generator, mechanical linking and coupling elements between a rotor hub that supports rotor blades and a corresponding electric generator etc., that are to be arranged or are arranged within a wind turbine nacelle.

Such support structures are typically subjected to high, in particular also oscillating, mechanical loads which are attributable substantially to the weight of the wind turbine components to be supported and to mechanical vibrations that arise during operation of a wind turbine and propagate in corresponding support structures.

Accordingly, there is a continuous need for further development of corresponding support structures with regard to the mechanical properties and the mechanical stability thereof.

### SUMMARY

An aspect relates to specifying an improved support structure for supporting wind turbine components.

A further aspect relates to a support structure of the type mentioned at the beginning, which is distinguished according to embodiments of the invention in that the cross-connection structure comprises at least two connecting struts which intersect in an intersection region.

The support structure according to embodiments of the invention comprises, as essential parts, at least two girder section structures and at least one cross-connection structure connecting the latter. The cross-connection structure comprises at least two connecting struts which are arranged relative to one another such that they intersect in an intersection region.

The connecting struts that form the cross-connection structure can be connected indirectly or directly to the girder section structures. An indirect connection should be understood as meaning that a connecting strut is joined to a girder section structure with at least one further component being interconnected and is thus connected indirectly to the girder section structure via the at least one interconnected component. Correspondingly, a direct connection should be understood as meaning that a connecting strut is joined to a girder section structure without at least one further component being interconnected and is thus connected directly to the girder section structure. Of course, it is conceivable for a connecting strut to be connected indirectly to a girder section structure by way of a first connecting region and directly to a further girder section structure by way of a second connecting region. Respective connecting regions are typically arranged, formed or established in the region of the free ends of a connecting strut.

As mentioned, at least two connecting struts of a corresponding cross-connection structure intersect in an intersection region. Corresponding intersecting connecting struts accordingly each extend (substantially) diagonally between the girder section structures, following different diagonals with their respective longitudinal extents.

One connecting strut can be arranged above or below a further connecting strut, at least in the intersection region. The connecting struts are in this case located in different parallel spatial planes, at least in the intersection region. In this variant, the cross-connection structure can have connecting struts of the same type, i.e. connecting struts having an identical geometric constructive configuration.

One connecting strut can also extend through a further connecting strut in the intersection region. The further connecting strut is, as explained below, configured or designed for this purpose such that it forms a passage means for the or at least one connecting strut passing through it. The connecting struts are located here in the same spatial plane, at least in the intersection region. In this variant, the cross-connection structure typically has connecting struts of different types, i.e. connecting struts having a different geometric constructive configuration. A first type is in this case typically formed with a passage segment that forms a passage means, or comprises at least one corresponding passage segment. A second type is formed without a corresponding passage segment, or does not comprise a corresponding passage segment.

The intersection, or the intersecting profile, of corresponding connecting struts generally implies that the connecting struts enclose or define a particular intersection angle. The intersection angle is typically in a range between 70 and 120°, in particular 90°. Of course, the intersection angle can be changed by changing the orientation of at least one connecting strut and can thus be below 70° or above 120°.

The girder section structures are typically in the form of elongate, metal components, i.e. components formed in particular from steel. The girder section structures can have for example I- or T-shaped cross sections, and so the girder section structures can accordingly be I- or T-girders.

The girder section structures are typically arranged such that each girder section structure has a side face located opposite a side face of a further girder section structure. This should be understood as meaning in particular a parallel arrangement or orientation of corresponding girder section structures. Given a parallel arrangement or orientation, the spacing between corresponding side faces of the girder section structures does not change along their respective longitudinal extents. Of course, it is in principle also conceivable not to arrange or orient the girder section structures in a parallel manner. Given a non-parallel arrangement or orientation, the spacing between corresponding side faces of the girder section structures changes along their respective longitudinal extents.

The connecting struts forming the cross-connection structure are typically elongate, metal components, i.e. components formed in particular from steel. The connecting struts can also be designated or considered to be rods or anchors. The cross section of the connecting struts is in principle freely selectable. Round, oval or polygonal cross sections can be mentioned merely by way of example.

Overall, the connection of corresponding girder section structures, according to embodiments of the invention, by means of a corresponding cross-connection structure produces a support structure having increased mechanical stability.

In the above description, it was explained that a cross-connection structure can comprise connecting struts of the same or different types.

In the latter case, provision is made of at least one connecting strut, designated first connecting strut, of a first type and of at least one connecting strut, designated second connecting strut, of a second or further type, wherein a first connecting strut is formed with at least one passage segment, said passage segment forming a passage means for at least one second connecting strut intersecting the first connecting strut. The first connecting strut is thus formed with a passage segment through which at least one second connecting strut is able to pass through which, in the assembled state of the cross-connection structure or, respectively, of the support structure, at least one second connecting strut passes. The passage segment is typically formed as a, for example, slot-like, passage opening extending in the longitudinal direction of the first connecting strut. In any case, the passage segment is in this embodiment an integral part of the first connecting strut.

In the case in which provision is made of at least one first and of at least one second connecting strut, it is also conceivable for a first connecting strut to comprise at least two axially successive connecting strut segments and at least one passage segment fitted between the at least two connecting strut segments, said passage segment forming a passage means for at least one second connecting strut intersecting the first connecting strut. In this embodiment, the first connecting strut thus comprises at least two axially successive connecting strut segments, between which at least one passage segment is located. In contrast to the abovementioned embodiment, the passage segment is in this embodiment not an integral part of a first connecting strut. The passage segment is in this case typically a separate component fitted between corresponding connecting strut segments. It is also conceivable for the passage segment to be part of one of the two connecting strut segments and accordingly to be formed with a passage segment. The first connecting strut then consists of at least of two components. In an analogous manner to the above-described exemplary embodiment, at least one second connecting strut is able to pass through the passage segment or, in the assembled state of the cross-connection structure or, respectively, of the support structure, at least one second connecting strut passes through the passage segment. The passage segment typically comprises a, for example, slot-like, passage opening extending in the longitudinal direction of the first connecting strut.

Of course, it is possible for the cross-connection structure to comprise different first connecting struts, i.e. first connecting struts according to the different embodiments described.

It is expedient for corresponding first and second connecting struts not to be in contact at least in the intersecting region. In other words, it is expedient for a second connecting strut to pass in a contact-free manner through a corresponding passage segment as an integral or separate part of a first connecting strut. A second connecting strut extending through a corresponding passage segment therefore does not come into contact with the passage segment through which it passes. In this way, for example, transmission of vibrations between the two connecting struts can be prevented. Equally, the cross-connection structure can be easily mounted or assembled in this way.

The connecting struts are typically connected, in particular in the region of their respective free ends, to the respective girder section structures via releasable connecting means. In this way, a releasable connection can be formed between corresponding connecting struts and corresponding girder section structures. A releasable connection means in particular that it is possible to release the respective connecting partner without damaging or destroying at least one of the connecting partners.

A corresponding releasable connection is realized in particular via releasable connecting means. Such releasable connecting means are suitable in particular for forming a releasable screw connection. Corresponding releasable connecting means are accordingly primarily screws, screw bolts and associated nuts or, respectively, component sections that have threaded bores and are formed in particular on a girder section structure and/or a connecting strut.

As mentioned, it is conceivable for at least one connecting strut to be connected indirectly to a girder section structure, i.e. with at least one further component being interconnected. Accordingly, it is possible for at least one connecting strut to be connected, in particular in the region of at least one free end, to at least one, in particular plate-like, connecting element via releasable connecting means, said connecting element being fitted between said connecting means and a respective girder section structure, wherein the at least one connecting element is for its part connected to the respective girder structure via releasable connecting means. A corresponding connecting element is also typically a metal component, i.e. a component made in particular of steel.

Corresponding releasable connecting means can again be those which are suitable for forming a releasable screw connection, and thus primarily screws, screw bolts and associated nuts or, respectively, component sections that have threaded bores and are formed in particular on a girder section structure and/or a connecting strut.

In order to further increase the mechanical stability of the support structure, it is conceivable for the girder section structures to be mutually braced by means of the cross-connection structure. Accordingly, tension and tensile forces can be applied to the girder section structures via the cross-connection structure, i.e. corresponding connecting struts associated therewith. This can be realized for example in that the spacing between corresponding connecting-strut connecting regions is decreased in the axial direction, and so a tension or tensile force is exerted on the girder section structure connected via the connecting struts.

The change in the spacing of the respective connecting-strut connecting regions can be realized for example in that the connecting regions are screwed onto respective threads formed in the region of the free ends of a connecting-strut bolt, such that said connecting regions are changeable in their axial position relative to one another via the screw connection formed in this way.

The mechanical stability of the support structure can furthermore be increased in that the girder section structures are additionally connected via at least one girder section, wherein the at least one girder section extends between the girder section structures without intersecting a connecting strut. The girder section or the at least one further girder section typically extends transversely between corresponding girder section structures. The girder section can be for example a metal I- or T-girder, i.e. in particular an I- or T-girder formed from steel.

The mechanical stability of the support structure can additionally be increased in that at least two of the girder sections are additionally connected via at least one further girder section. The at least one further girder section accordingly extends longitudinally and thus parallel to the girder section structures. The further girder section can also be for example a metal I- or T-girder, i.e. in particular an I- or T-girder formed from steel.

All of the further girder sections are expediently attached releasably together or to corresponding girder section structures. Accordingly, the girder sections can be positioned appropriately and optionally temporarily removed; this can be advantageous for example in the context of servicing wind turbine components. A releasable connection also means in this connection in particular that it is possible to release the respective connecting partner without damaging or destroying at least one of the connecting partners.

A corresponding releasable connection is realized, here too, in particular via releasable connecting means. Such releasable connecting means are suitable in particular for forming a releasable screw connection. Corresponding releasable connecting means are accordingly primarily screws, screw bolts and associated nuts or, respectively, component sections that have threaded bores.

Embodiments of the invention also relate to a wind turbine nacelle, comprising at least one support structure as described. Thus, all of the statements given in connection with the support structure apply analogously to the wind turbine nacelle. Various wind turbine components, for example an electric generator, a cooling device assigned thereto, mechanical linking and coupling elements between a rotor hub that supports rotor blades and a corresponding electric generator etc., are mounted in the wind turbine nacelle. The wind turbine components are in this case typically supported indirectly or directly on the support structure.

Moreover, the invention relates to a wind turbine which comprises a corresponding wind turbine nacelle. Accordingly, all of the statements given in connection with the support structure also apply analogously to the wind turbine. The wind turbine nacelle is typically arranged on a wind-turbine tower construction.

### BRIEF DESCRIPTION

Some of the embodiments will be described in detail, with reference to the following figures, wherein like designations denote like members, wherein:

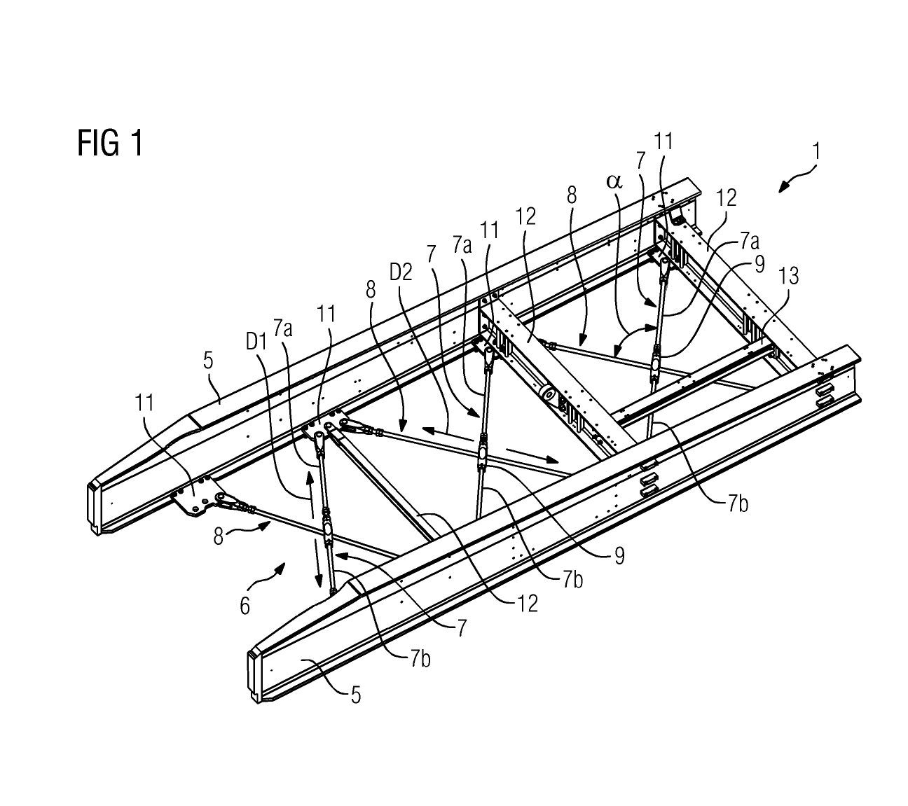

FIG. 1 shows a first illustration of an embodiment of a support structure;

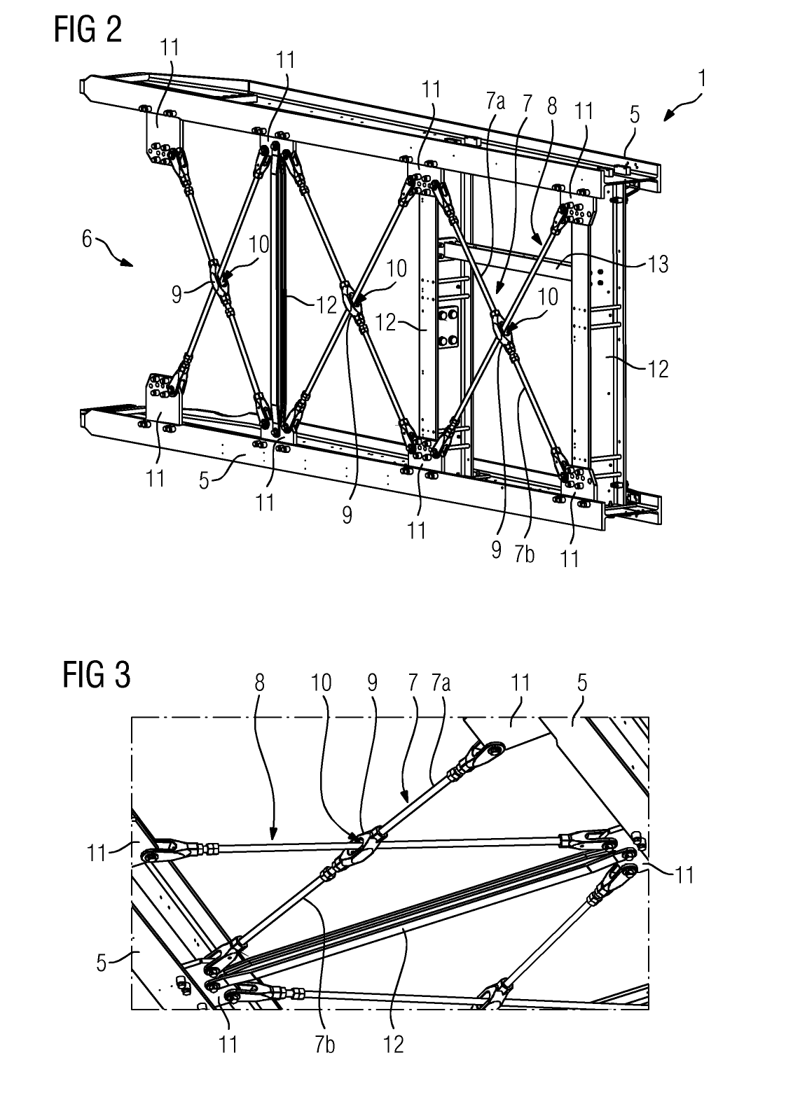

FIG. 2 shows a second illustration of an embodiment of the support structure;

FIG. 3 shows a third illustration of an embodiment of the support structure; and

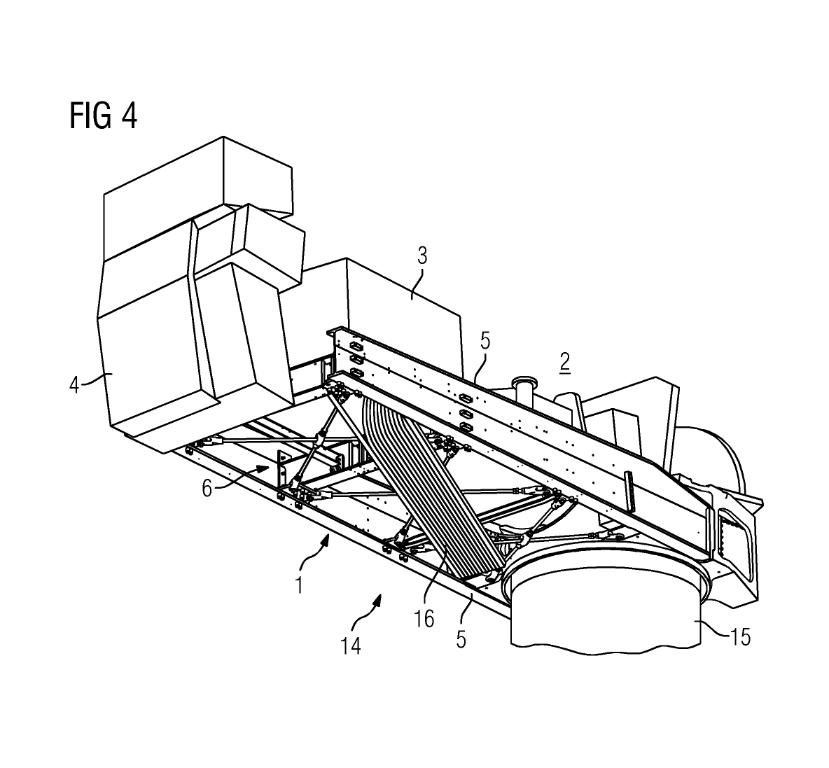

FIG. 4 shows an illustration of a detail of an embodiment of a wind turbine.

### DETAILED DESCRIPTION

FIGS. 1-3 each show an illustration of a support structure 1 according to one exemplary embodiment of the invention. As can be seen, FIG. 1 shows a perspective view of the top side of the support structure 1, FIG. 2 shows a perspective view of the underside of the support structure 1, and FIG. 3 shows a view of a detail of the support structure 1.

The support structure 1 serves generally for supporting wind turbine components which are to be arranged or are arranged within a wind turbine nacelle 2 (cf. FIG. 4) that is to be arranged or is arranged on a wind-turbine tower construction 15 (cf. FIG. 4). Corresponding wind turbine components are for example an electric generator 3, a cooling device 4 assigned thereto, mechanical linking and coupling elements (not shown) between a rotor hub (not shown) that supports rotor blades and a corresponding electric generator 3 etc. Generally, corresponding wind turbine components are all those components which are to be arranged or are arranged within the wind turbine nacelle 2 and are thus supported indirectly or directly on the support structure 1.

The support structure 1 comprises two girder section structures 5 that are arranged or oriented in a parallel manner. The girder section structures 5 are steel profiles having an I-shaped cross section and are thus I-girders.

As can be seen, the girder section structures 5 are connected together via a cross-connection structure 6. The cross-connection structure 6 comprises a number of connecting struts 7, 8. The connecting struts 7, 8 are one- or multipart rod-like steel components having a rounded cross section. As can be gathered in the following text, the connecting struts 7, 8 can be designated or considered to be tie rods.

As can be seen, the connecting struts 7, 8 each extend diagonally between the girder section structures 5. First connecting struts 7 extend between the girder section structures 5 in the direction of a first diagonal indicated by the double arrow D1. Second connecting struts 8 extend between the girder section structures 5 in a manner perpendicular thereto and thus in the direction of a second diagonal indicated by the double arrow D2.

As a result, in each case one first connecting strut 7 intersects in each case one second connecting strut 8 in an intersection region. Intersecting connecting struts 7, 8 can be designated or considered to be a connecting-strut pair. Intersecting connecting struts 7, 8 enclose, or define, an intersection angle a. The intersection angle a is typically about 90°.

However, the first connecting struts 7 differ from the second connecting struts 8 not only by way of their direction of extent but also by way of their functional or structural configuration.

As can be seen in particular from FIGS. 1-3, the intersection of the connecting struts 7, 8 is realized in that respective second connecting struts 8 pass through respective first connecting struts 7 in the intersection region. This is enabled in that respective first connecting struts 7 have a passage segment 9 in a central region with respect to their longitudinal extent, said passage segment 9 forming a passage means for at least one second connecting strut 8 intersecting the respective first connecting strut 7. The intersecting connecting struts 7, 8 are not in contact, in particular in the intersection region.

The passage segment 9, which has a slot-like passage opening 10 and extends axially, i.e. in the longitudinal direction of the respective first connecting strut 7, (cf. in particular FIG. 3), is fitted as a separate component between two connecting strut segments 7a, 7b. The passage segment 9 thus connects the respective mutually opposite free ends of respective connecting strut segments 7a, 7b. Accordingly, a first connecting strut 7 consists at least of two connecting strut segments 7a, 7b and a passage segment 9 fitted between the latter.

In principle, however, it is also conceivable not to fit a corresponding passage segment 9 as a separate component between corresponding connecting strut segments 7a, 7b, but to form a first connecting strut 7 integrally with a passage segment 9.

The connection of the connecting struts 7, 8 to the girder section structures 5 is realized by means of releasable screw connections. As can be seen, in each case a plate-like connecting element 11 is fitted in this case between the connecting struts 7, 8 and the girder section structures 5, said plate-like connecting element 11 having connecting points for a connecting strut 7, 8 on one side and connecting points for a girder section structure 5 on the other side. The connecting struts 7, 8 are accordingly connected indirectly to the girder section structures 5.

Specifically, the connection between the connecting struts 7, 8 and a corresponding connecting element 11 takes place by means of releasable connecting means, i.e. screws or screw bolts, which pass not only through bores, optionally provided with a thread, in respective connecting-strut claw-like connecting regions but also through bores, optionally provided with a thread, within the connecting element 11. The screws are fixed by means of nuts. The nuts likewise represent parts of respective releasable connecting means.

The connection of the connecting elements 11 to the girder section structures 5 takes place in an analogous manner. I.e., releasable connecting means, which pass through respective bores, optionally provided with a thread, within the connecting elements 11 and within the girder section structures 5 and are fixed by means of nuts, are used here, too.

The girder section structures 5 can be mutually braced equally via the cross-connection structure 6 formed by the connecting struts 7, 8. Accordingly, tension and tensile forces can be exerted on the girder section structures 5 via the connecting struts 7, 8, in the manner of tie rods.

As can be seen, further girder sections 12, 13 additionally extend between the girder section structures 5. The girder sections 12 that project in a perpendicular manner from mutually opposite side faces of the girder section structures 5 and thus extend transversely to the longitudinal axis of the girder section structures 5 confer additional mechanical stability on the support structure 1. As can be seen, the girder sections 12 do not intersect the connecting struts 7, 8.

Respective girder sections 12 can be connected indirectly, via corresponding connecting elements 11, or directly to the girder section structures 5. The girder sections 12 can be connected together by means of further girder sections 13 that extend parallel to the longitudinal axis of the girder section structures 5, as is illustrated by way of example in FIG. 1.

FIG. 4 shows an illustration of a detail of a wind turbine 14 according to one exemplary embodiment of the invention. The region of a wind turbine nacelle 2 mounted on a tower construction 15 is illustrated. As can be seen, a cable run 16 is attached to the girder section structures 5, with various, in particular electrical, cables being guided or held via said cable run 16. The housing of the wind turbine nacelle 2 is not shown in order to show the wind turbine components arranged within the latter more clearly.

Although the invention has been illustrated and described in detail by the preferred exemplary embodiment, the invention is not restricted by the disclosed examples and other variations can be derived therefrom by a person skilled in the art without departing from the scope of protection of the invention.

1. A support structure for supporting wind turbine components which are to be arranged or are arranged within a wind turbine nacelle that is to be arranged or is arranged on a tower construction, the support structure comprising:
at least two girder section structures that are connected together via at least one cross-connection structure, wherein the at least one cross-connection structure comprises at least two connecting struts that intersect in an intersection region.

2. The support structure as claimed in claim 1, further comprising at least one first connecting strut and at least one second connecting strut, wherein the at least one first connecting strut is formed with at least one passage segment, the at least one passage segment forming a passage means for the at least one second connecting strut intersecting the at least one first connecting strut.

3. The support structure as claimed in claim 1, further comprising at least one first connecting strut and of at least one second connecting strut, wherein the at least one first connecting strut comprises at least two axially successive connecting strut segments and at least one passage segment fitted between the at least two axially successive connecting strut segments, the at least one passage segment forming a passage means for the at least one second connecting strut intersecting the at least one first connecting strut.

4. The support structure as claimed in claim 2, wherein corresponding first and second connecting struts are not in contact at least in the intersecting region.

5. The support structure as claimed in claim 1, wherein the at least two connecting struts intersect at an intersection angle in a range between 70 and 120°.

6. The support structure as claimed in claim 1, wherein the at least two connecting struts are connected in the region of their respective free ends, to the respective at least two girder section structures via releasable connecting means.

7. The support structure as claimed in claim 1, wherein at least one connecting strut is connected in the region of one of its respective free ends, to at least one plate-like connecting element via releasable connecting means, the at least one plate-like connecting element being fitted between the releasable connecting means and a respective girder section structure, wherein the at least one plate-like connecting element is for its part connected to the respective girder section structure via releasable connecting means.

8. The support structure as claimed in claim 6, wherein the releasable connecting means are designed to form a releasable screw connection.

9. The support structure as claimed in claim 8, wherein the releasable connecting means comprise at least one screw, at least one screw bolt and at least one associated nut or, respectively, at least one component section that has a threaded bore and is formed in particular on a girder structure and/or on a connecting element.

10. The support structure as claimed in claim 1, wherein the girder section structures are mutually braceable or braced by means of the cross-connection structure.

11. The support structure as claimed in claim 1, wherein the girder section structures are additionally connected via at least one girder section, wherein the at least one girder section extends between the at least two girder section structures without intersecting a connecting strut.

12. The support structure as claimed in claim 11, wherein at least two girder sections are connected via at least one further girder section.

13. A wind turbine nacelle comprising at least one support structure as claimed in claim 1.

14. A wind turbine comprising a wind turbine nacelle as claimed in claim 13.
